(19) United States
(12) Patent Application Publication
(10) Pub. No.: US 2025/0329043 A1
(43) Pub. Date: Oct. 23, 2025

(54) THERMAL IMAGE-BASED TRACKING TO MATE CONNECTORS OF VEHICLES

(71) Applicant: THE BOEING COMPANY, Arlington, VA (US)

(72) Inventors: Ryan P. McClintock, Brentwood, MO (US); Caleb G. Price, Brentwood, MO (US); Christian Louis Carini, St. Louis, MO (US)

(21) Appl. No.: 18/776,764

(22) Filed: Jul. 18, 2024

Related U.S. Application Data
(60) Provisional application No. 63/637,665, filed on Apr. 23, 2024.

(51) Int. Cl. G06T 7/73; B64D 39/06; B64D 45/00; G06T 7/60; G06V 10/147; G06V 10/25; G06V 10/28; G06V 10/74; G06V 10/762

(52) U.S. Cl. CPC G06T 7/73; B64D 45/00; G06T 7/60; G06V 10/147; G06V 10/25; G06V 10/28; G06V 10/761; G06V 10/762; B64D 39/06; G06T 2207/10032; G06T 2207/10048; G06T 2207/30244

(57) ABSTRACT

A device includes a thermal imaging sensor and a vision processor. The thermal imaging sensor is configured to generate thermal image data depicting at least a portion of a vehicle. The vision processor is configured to perform thresholding on the thermal image data to generate a thresholded thermal image including pixels having intensity values that satisfy a threshold. The vision processor is also configured to identify one or more regions of interest in the thresholded thermal image based on pixel characteristics associated with the one or more regions of interest. The vision processor is further configured to estimate a range between the device and the vehicle based on the one or more regions of interest.

### CROSS-REFERENCE TO RELATED APPLICATIONS

The present application claims the benefit of U.S. Provisional Patent Application No. 63/637,665 entitled “THERMAL IMAGE-BASED TRACKING TO MATE CONNECTORS OF VEHICLES,” filed Apr. 23, 2024, the contents of which are incorporated herein by reference in their entirety.

### FIELD OF THE DISCLOSURE

The present disclosure is generally related to thermal image-based tracking to mate connectors of vehicles.

### BACKGROUND

Highly skilled human operators are typically used to guide complex, high-speed docking operations, such as air-to-air refueling and spacecraft docking operations. As such, the operations rely heavily on human judgment, which is sometimes supplemented by computer vision techniques. To illustrate, complex stereoscopic vision systems may be used to aid the human operator in mating connectors (e.g., a receiver and refueling boom or docking connectors). These docking operations can be complex and involve precision maneuvers, making such operations difficult to extend to autonomous vehicles such as drones, drone aircraft, or autonomous spacecraft. Additionally, artificial intelligence-based solutions can be challenging to test, resulting in difficulty certifying such systems with industry organizations or governments.

### SUMMARY

In a particular implementation, a device includes a thermal imaging sensor and a vision processor. The thermal imaging sensor is configured to generate thermal image data depicting at least a portion of a vehicle. The vision processor is configured to perform thresholding on the thermal image data to generate a thresholded thermal image including pixels having intensity values that satisfy a threshold. The vision processor is also configured to identify one or more regions of interest in the thresholded thermal image based on pixel characteristics associated with the one or more regions of interest. The vision processor is further configured to estimate a range between the device and the vehicle based on the one or more regions of interest.

In another particular implementation, a method includes obtaining, via a thermal imaging sensor of a first vehicle, thermal image data depicting at least a portion of a second vehicle. The method also includes performing thresholding on the thermal image data to generate a thresholded thermal image including pixels having intensity values that satisfy a threshold. The method includes identifying one or more regions of interest in the thresholded thermal image based on pixel characteristics associated with the one or more regions of interest. The method further includes estimating a range between the first vehicle and the second vehicle based on the one or more regions of interest.

In another particular implementation, a non-transitory, computer-readable medium stores instructions that, when executed by one or more processors, cause the one or more processors to perform operations including performing, at a first vehicle, thresholding on thermal image data to generate a thresholded thermal image including pixels having intensity values that satisfy a threshold. The thermal image data depicts at least a portion of a second vehicle. The operations also include identifying one or more regions of interest in the thresholded thermal image based on pixel characteristics associated with the one or more regions of interest. The operations further include estimating a range between the first vehicle and the second vehicle based on the one or more regions of interest.

The features, functions, and advantages described herein can be achieved independently in various implementations or may be combined in yet other implementations, further details of which can be found with reference to the following description, drawings, and appendix.

### BRIEF DESCRIPTION OF THE DRAWINGS

FIGS. 1A-E illustrate examples of a system configured to perform thermal image-based tracking to mate connectors of vehicles.

FIG. 2 is a diagram that illustrates an example of a system configured to perform thermal image-based tracking to mate connectors of vehicles.

FIGS. 3A and 3B depict an example of a thermal image and an example of a thresholded thermal image used to perform thermal image-based tracking to mate connectors of vehicles.

FIG. 4 depicts an example of data tables that include pixel characteristics and scores associated with clusters of pixels of the thresholded thermal image of FIG. 3B.

FIGS. 5A and 5B depict an example of a thermal image and an example of a thresholded thermal image used to perform thermal image-based tracking to mate connectors of vehicles.

FIG. 6 depicts an example of data tables that include pixel characteristics and scores associated with clusters of pixels of the thresholded thermal image of FIG. 5B.

FIG. 7 is a diagram that illustrates a flow chart of an example of a method of performing thermal image-based tracking to mate connectors of vehicles.

FIG. 8 is a flowchart illustrating an example of a life cycle of an aircraft including a vision system configured to perform thermal image-based tracking to mate connectors of vehicles.

FIG. 9 is a block diagram of a particular implementation of the aircraft associated with the life cycle of FIG. 8.

FIG. 10 is a block diagram of a computing environment including a computing device configured to support aspects of computer-implemented methods and computer-executable program instructions (or code) according to the present disclosure.

### DETAILED DESCRIPTION

Aspects disclosed herein present systems and methods of thermal image-based tracking of a connector of a vehicle to be mated with a connector of an autonomous or semi-autonomous vehicle. For example, a vision processor that resides onboard a first aircraft can process thermal image data from a thermal imaging sensor, such as an infrared camera, to identify and track a second aircraft depicted in the thermal image data. The first aircraft includes a drone aircraft, another type of autonomous aircraft or spacecraft, or a semi-autonomous aircraft or spacecraft that implements an autonomous aerial refueling receive (A2R2) capability or autonomous docking capability, and the second aircraft includes an aircraft or spacecraft, another autonomous or semi-autonomous aircraft, or an autonomous or semi-autonomous spacecraft, such as a refueling tanker, that includes a second connector with which a first connector of the first aircraft is configured to mate. In implementations described herein, the first connector includes a probe, a fuel receptacle, a docking appendage, or the like, and the second connector includes a drogue, a drogue basket, a refueling boom, a docking clamp or receptacle, or the like. In some implementations, the vision processor outputs a range estimate (e.g., a distance estimate) between the first aircraft and the second aircraft (or between the probe and the drogue) and, optionally, position information of the second aircraft to one or more other processor(s), such as a guidance processor of a navigation system, to enable the guidance processor to determine and initiate the performance of maneuvers to guide the first aircraft to mate the first connector (e.g., the probe) to the second connector (e.g., the drogue). As an example, the range estimate and/or the position information output by the vision processor can enable the guidance processor to maneuver the first aircraft such that a refueling connector (e.g., the probe) is mated to a refueling port (e.g., the drogue) of the second aircraft during air-to-air refueling operations. As another example, the range estimate and/or the position information output by the vision processor of a first spacecraft can enable the guidance processor to maneuver the first spacecraft such that one spacecraft is docked to another spacecraft (e.g., via mating the first and second connectors). In implementations, the vision processor is used to support the guidance processor instead of using a human operator to reduce costs, such as costs associated with training human operators and costs associated with operations to mate connectors.

In some contexts, the two aircraft performing mating (e.g., of connectors) include a primary aircraft and a secondary aircraft. Although the terms may be arbitrarily assigned in some contexts (such as where two peer aircraft are mating), generally, the primary aircraft refers to an aircraft that is connecting to the secondary aircraft to be serviced by the secondary aircraft, or the primary aircraft refers to the aircraft, onboard which the vision processor resides. To illustrate, in an air-to-air refueling context, the primary aircraft is the receiving aircraft (e.g., the aircraft to be refueled). Likewise, the secondary aircraft refers to the other aircraft of a pair of aircraft. To illustrate, in the air-to-air refueling context, the secondary aircraft is the tanker aircraft. Although predominately referred to herein as aircraft, the first aircraft and the second aircraft can also be referred to as a first device and a second device, with the term device used broadly to include an object, system, or assembly of components that is/are operated upon as a unit (e.g., in the case of the secondary device) or that operate cooperatively to achieve a task (e.g., in the case of the primary device).

In a particular aspect, the first aircraft uses a thermal imaging device (e.g., a long-wave infrared (LWIR) camera) to capture thermal images of at least a portion of each of the second aircraft and, optionally, the second connector. For example, the thermal imaging device can capture thermal images of a portion of a refueling tanker, such as a back portion in which the exhaust from the engines is visible. The vision processor performs thresholding on the thermal images to generate thresholded thermal images that include pixels having intensity values that satisfy (e.g., are greater than or equal to) a threshold. Thresholding the thermal images can reduce the number of pixels to those associated with very high temperatures, such as engines of the second aircraft. In implementations, the vision processor identifies one or more regions of interest in the thresholded thermal images based on pixel characteristics, for example by clustering pixels into groups based on similar pixel characteristics such as pixel count, intensity value, cluster circularity, cluster size, cluster density, or a combination thereof, and by scoring the clusters to identify one or more highest scoring clusters as the regions of interest.

In aspects, the vision processor estimates a range between the first aircraft and the second aircraft based on the one or more regions of interest and outputs the estimated range to another processor, such as a guidance processor, for navigation and control of the first aircraft based on the estimated range. For example, the vision processor can map multiple regions of interest to known vehicle geometries (e.g., a group of predefined vehicle geometries having two engines/known engine geometries) to identify the second aircraft and to determine the range to the second aircraft based on pixel distances between regions of interest and distances between engines for the selected vehicle geometry. As another example, the vision processor can map a single region of interest to known vehicle geometries (e.g., a group of predefined vehicle geometries having a single engine/known engine size and shape) to identify the second aircraft and/or estimate the range based on a size and shape of the single region of interest and the size and shape of the selected vehicle geometry. Optionally, the vision processor estimates position information of the second aircraft based on the one or more regions of interest, position information of the first aircraft, a field of view of the thermal imaging sensor, a relative position of the thermal imaging sensor with respect to the first aircraft, or a combination thereof, and the estimated position information is provided to the guidance processor for use in determining maneuvers for the first aircraft.

One benefit of the disclosed systems and methods is that the vision processor and the thermal imaging sensor provide an all-optical, passive solution for mating connectors of vehicles during flight, such as for aerial refueling of aircraft or docking of spacecraft, which provides a high confidence solution at close range. For example, by leveraging the high temperatures of engine exhaust and known aircraft geometries, the vision processor described in aspects herein can threshold thermal images of another aircraft to identify, track, and estimate the range to the other aircraft without significantly increasing the processing resources or sensors onboard an autonomous or semi-autonomous aircraft. The systems and methods disclosed herein can provide autonomous mating of connectors between aircraft in situations in which global positioning satellite (GPS)-based systems and/or inertial navigation system (INS)-based solutions are inoperable or have lower reliability, without significantly increasing cost or complexity of the systems onboard the autonomous or semi-autonomous aircraft. Additionally, or alternatively, the range estimation provided by the vision processor can be combined with (e.g., by using as a safety check or verification for) a GPS-based or INS-based solution to provide a holistic refueling or docking system with high reliability and confidence. Further, using vision-based maneuvering to control aircraft or spacecraft during complicated maneuvers, such as aerial refueling or docking, can reduce costs and resources as compared to training human operators to control the aircraft, as well as providing more predictable and repeatable maneuvers than using human operators.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, a system may be described herein as including one or more computing devices (“computing device(s)”), which indicates that in some implementations the system includes a single computing device and in other implementations the system includes multiple computing devices. For ease of reference herein, such features are generally introduced as “one or more” features, and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent; and the term “approximately” may be substituted with “within 10 percent of” what is specified. The statement “substantially X to Y” has the same meaning as “substantially X to substantially Y,” unless indicated otherwise. Likewise, the statement “substantially X. Y, or substantially Z” has the same meaning as “substantially X, substantially Y, or substantially Z,” unless indicated otherwise.

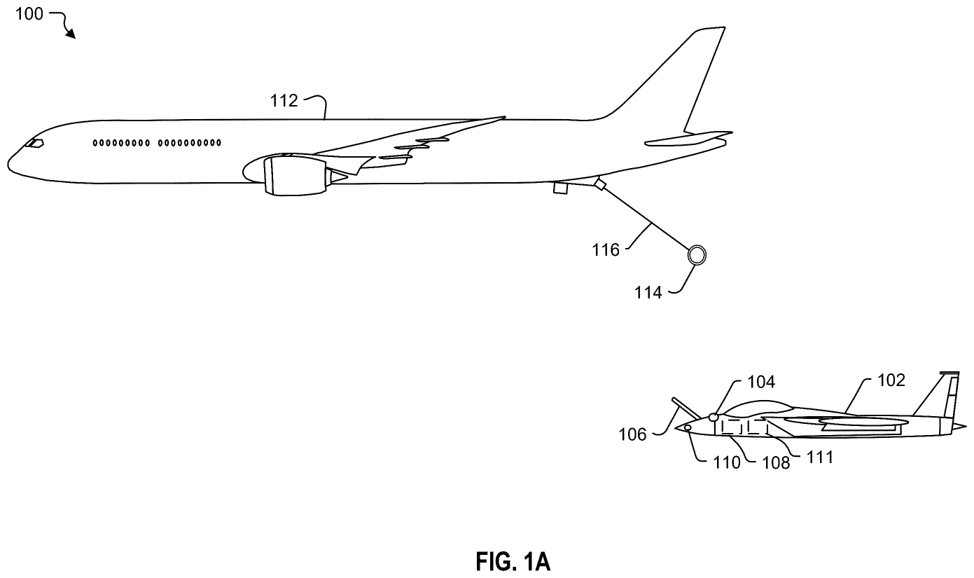

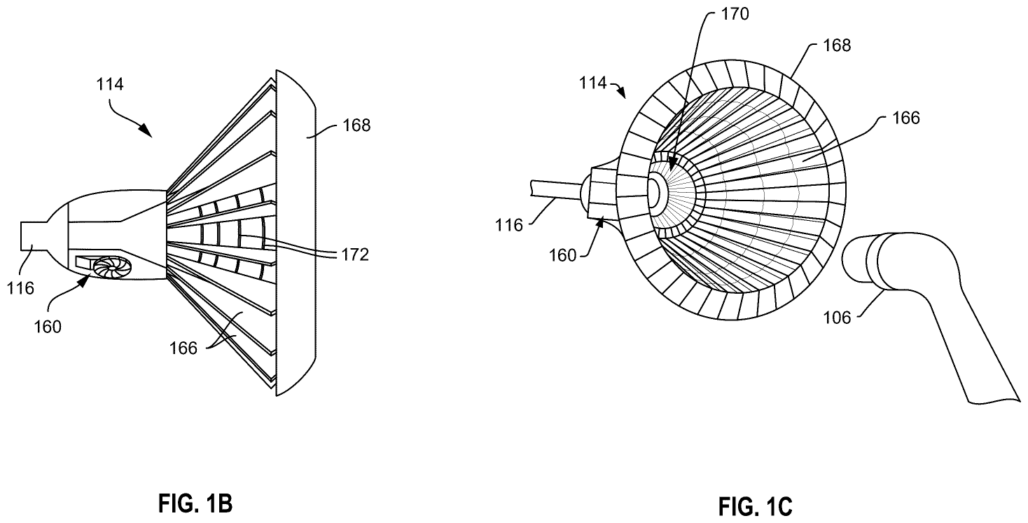

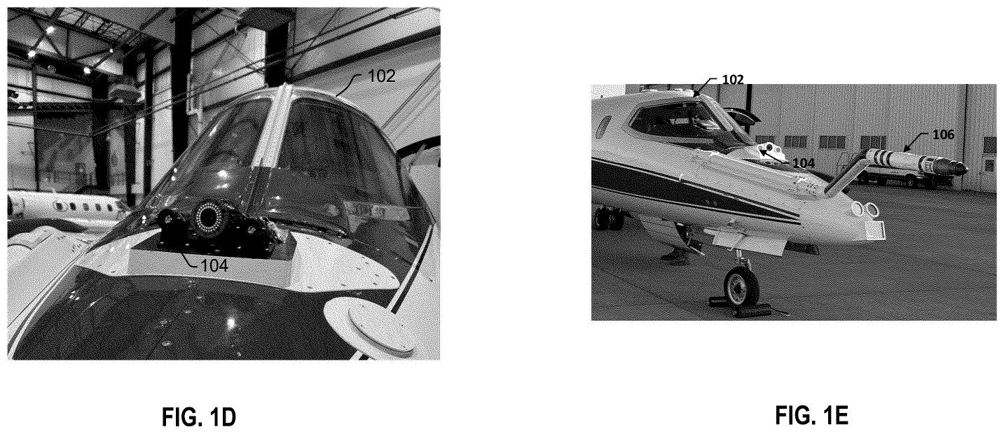

FIGS. 1A-1E illustrate examples of a system 100 configured to perform thermal image-based tracking to mate connectors of vehicles according to one or more aspects of the present disclosure. FIG. 1A is a diagram that illustrates the system 100 including a first aircraft 102 and a second aircraft 112. FIG. 1B is a diagram of a side-view of an example of a drogue 114 of the second aircraft 112. FIG. 1C is a diagram of an example of the drogue 114 and a probe 106 of the first aircraft 102. FIGS. 1D and 1E are each an image of an example of the first aircraft 102.

Referring to FIG. 1A, the system 100 includes the first aircraft 102 and the second aircraft 112. The first aircraft 102 is configured to identify and track the second aircraft 112 or the drogue 114 (e.g., a basket) of the second aircraft 112 based on thermal image data, and optionally position data, such that the first aircraft 102 can perform one or more maneuvers to mate the probe 106, also referred to as a first connector, of the first aircraft 102 with the drogue 114, also referred to as a second connector, of the second aircraft 112. In the example illustrated in FIG. 1A, the first aircraft 102 includes or corresponds to an autonomous aircraft, such as a drone or drone aircraft, an autonomous or semi-autonomous aircraft (e.g., an aircraft having A2R2 capability), an autonomous or semi-autonomous spacecraft, or the like (a primary device, as described above), and the second aircraft 112 includes or corresponds to a fuel tanker (a secondary device, as described above). For example, the second aircraft 112 can be configured to service or support the first aircraft 102, such as providing fuel or a refueling service, and the first aircraft 102 includes a device or system configured to couple to the second aircraft 112 and possibly to be serviced by or supported by the second aircraft 112. Although described in the context of a fuel tanker and an autonomous or semi-autonomous aircraft, in other implementations, the first aircraft 102 can include other types of aircraft or spacecraft, such as a space shuttle, and the second aircraft 112 can include other types of aircraft of spacecraft, such as a space station with which the first aircraft 102 is configured to dock.

The second aircraft 112 is coupled via a hose 116 to the drogue 114. The first aircraft 102 includes the probe 106 that is configured to couple with (e.g., physically attach to) the drogue 114. The second aircraft 112 is configured to provide fuel via the hose 116 to the first aircraft 102 while the probe 106 is coupled to the drogue 114. Although the drogue 114 is illustrated in FIG. 1A as being coupled to the second aircraft 112 via the hose 116, in some other implementations, the second aircraft 112 includes a moveable coupling system configured to move the drogue 114 (or another type of connector) relative to the probe 106 (or another type of connector) of the first aircraft 102. For example, the moveable coupling system of the second aircraft 112 can include a steerable boom (e.g., a refueling boom) of a refueling system or a steerable docking arm of a docking system. The above referenced examples are merely illustrative and are not limiting. Additionally, the second aircraft 112 includes a fuel tank to supply fuel, via the hose 116 (or a refueling boom), to the first aircraft 102.

Referring to FIGS. 1B and 1C, the drogue 114 includes a reception coupling 160 and an array of structures 166 (also referred to herein as arms or spokes) extending therefrom and which support a canopy 168 at the distal ends thereof. The reception coupling 160 includes an internal passage 170 (e.g., a socket) for receiving a refueling probe (e.g., the probe 106) and is attached to a fuel hose (e.g., the hose 116). The structures 166 surround the entrance to the internal passage 170 and may each be joined to adjacent arms by couplings 172 (e.g., tie ropes, wires, or other material) for avoiding penetration between the structures 166 by the probe 106. The structures 166 may each have a planar (or substantially planar) body portion, extending radially from an opening/center of the internal passage 170 (e.g., socket) of the drogue 114.

Referring to FIGS. 1A, 1D, and 1E, the first aircraft 102 includes a thermal imaging sensor 104. In an example, the thermal imaging sensor 104 includes a long-wave infrared (LWIR) camera or another type of infrared (IR) camera. The thermal imaging sensor 104 is configured to generate thermal image data (e.g., thermal image(s)) that depicts temperature information associated with at least a portion of the second aircraft 112. For example, the LWIR camera can be configured to generate thermal image data based on wavelengths ranging from 8 μm to 14 μm. In some implementations, the thermal image data represents a stream of real-time (e.g., subject to only minor video front-end processing delays and buffering) thermal image frames that represent relative temperatures and relative positions of at least a portion of the drogue 114, at least a portion of the second aircraft 112, or a combination thereof. In a particular aspect, the thermal imaging sensor 104 is located within a housing that is coupled to a hull of the first aircraft 102 and that includes an aperture that provides a field of view for the thermal imaging sensor 104. Alternatively, the thermal imaging sensor 104 can be located at or near an end of the probe 106. In some implementations, the first aircraft 102 includes multiple thermal imaging sensors 104 positioned at one or more locations with respect to the hull, the probe 106, or a combination thereof.

Referring to FIG. 1A, the first aircraft 102 also includes a vision processor 108, an optional memory (not shown in FIGS. 1A-1E), one or more additional processors 111, and optionally, one or more sensors 110. In the example illustrated in FIGS. 1A-1E, the vision processor 108 includes or corresponds to one or more image processors. In examples, the additional processor(s) 111 include or correspond to one or more guidance processors, one or more navigational processors, one or more processors of a flight control system, other types of processors, or a combination thereof. In some implementations, the vision processor 108 and the additional processor(s) 111 are combined. To illustrate, one or more graphics processing units (GPUs), one or more central processing units (CPUs), one or more field programmable gate arrays (FPGAs), one or more digital signal processors (DSPs), or one or more other multi-core or multi-thread processing units may serve as both the vision processor 108 and the additional processor(s) 111. Although some implementations include the memory, in other implementations, the memory is omitted from the first aircraft 102.

The sensor(s) 110, when present, are configured to generate supplemental sensor data (e.g., additional image and/or position data) indicative of relative positions of the first aircraft 102 and the second aircraft 112. For example, the sensor(s) 110 may include a camera, a video capture device, a light emitting diode (LED) device, position sensors (e.g., gyroscope(s), accelerometer(s), inertial navigation system (INS) sensors, and the like), and sensor data generated by the sensor(s) 110 can include additional image data, video data, position data, such as 6 degrees of freedom (6DoF) position data, INS data, or a combination thereof. Additionally, or alternatively, the sensor(s) 110 may include a range finder (e.g., a laser range finder and/or a radio with ranging capability, such as a tactical radio), and the sensor data generated by the sensor(s) 110 can include range data (e.g., a distance from the range finder to the second aircraft 112). Additionally, or alternatively, the sensor(s) 110 may include a radar system, and the sensor data generated by the sensor(s) 110 may include radar data (e.g., radar returns data indicating a distance to the second aircraft 112, a direction to the second aircraft 112, or both). Additionally, or alternatively, the sensor(s) 110 may include a light detection and ranging (lidar) system, and the sensor data generated by the sensor(s) 110 may include lidar data (e.g., lidar returns data indicating a distance to the second aircraft 112, a direction to the second aircraft 112, or both). Additionally, or alternatively, the sensor(s) 110 may include a sonar system, and the sensor data generated by the sensor(s) 110 may include sonar data (e.g., sonar returns data indicating a distance to the second aircraft 112, a direction to the second aircraft 112, or both). Additionally, or alternatively, the sensor(s) 110 may include one or more additional cameras (e.g., in addition to the thermal imaging sensor 104), and the sensor data generated by the sensor(s) 110 may include stereoscopic image data.

During operation, the first aircraft 102 can activate the thermal imaging sensor 104 to capture thermal image data representing at least a portion of the second aircraft 112. In implementations that include the sensor(s) 110, the sensor(s) 110 capture additional sensor data associated with the second aircraft 112, the drogue 114, or both. The vision processor 108 processes the thermal image data to detect a range estimate (e.g., an estimated distance between the first aircraft 102 and the second aircraft 112 or between the probe 106 and the drogue 114), a position estimate (e.g., coordinates) of the drogue 114, or both, and the vision processor 108 provides the range estimate and/or the position estimate to the additional processor(s) 111. In some implementations, the vision processor 108 processes the additional sensor data to detect other range estimates and/or other position estimates using other techniques and the additional sensor data, and the vision processor 108 provides the other range estimates and/or the other position estimates to the additional processor(s) 111. In this example, the vision processor 108 can provide scores (e.g., confidence scores) associated with the range estimate, the position estimate, the other range estimates, the other position estimates, or a combination thereof, to the additional processor(s) 111. The additional processor(s) 111 can determine navigation for the first aircraft 102 and/or maneuver the first aircraft 102, the probe 106, or both, based on the range estimate(s) and/or the position estimate(s) to engage the probe 106 with the drogue 114 to initiate refueling of the first aircraft 102.

Although FIGS. 1A-1E depict the first aircraft 102 including the sensor(s) 110, in some implementations the sensor(s) 110 are omitted or are not used to generate input to the additional processor(s) 111. For example, a range estimate and/or a position estimate may be determined solely based on thermal image data output by the thermal imaging sensor 104. Additionally, or alternatively, the vision processor 108 can perform one or more additional operations to identify or track the second aircraft 112 and/or the drogue 114, such as by using the sensor(s) 110.

The thermal imaging sensor 104 and the vision processor 108, in conjunction with other features of the first aircraft 102, improves efficiency (e.g., by reducing training costs), reliability, and repeatability of operations to mate the probe 106 and the drogue 114. For example, the vision processor 108 can process thermal image data generated by the thermal imaging sensor 104 to determine a range between the first aircraft 102 and the second aircraft 112 and/or position of the second aircraft 112 or the drogue 114 without the cost and complexity of integrating other types of sensors in the first aircraft 102. Additionally, or alternatively, the estimates generated by the vision processor 108 can be used to support estimates generated by other systems of the first aircraft 102, thereby improving the reliability and increasing confidence in the range and position estimations generated by the first aircraft 102. Such highly reliable range estimation is provided without significantly increasing the cost or complexity of the first aircraft 102, as the thermal imaging sensor 104 and the vision processor 108 represent a relatively small and low-cost portion of the overall processing resources and sensors onboard the first aircraft 102. The range/position estimates may be provided to the additional processor(s) 111, such as a guidance processor, which can mimic maneuvers performed by highly skilled human operators without the time and cost required to train the operators. Further, damage caused by improper maneuvers performed by automated aircraft or spacecraft can be reduced or eliminated by performing maneuvers that are determined based on the range estimates and/or position estimates output by the vision processor 108.

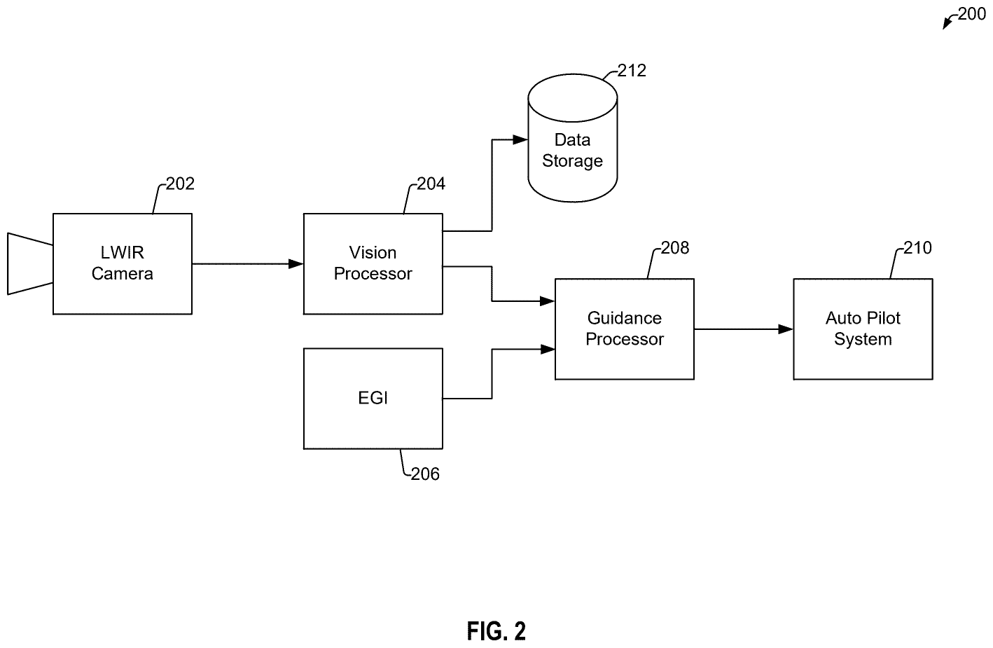

FIG. 2 is a diagram that illustrates a system 200 that is configured to perform thermal image-based tracking to mate connectors of vehicles. The system 200 is included in one or more devices, such as an autonomous or semi-autonomous aircraft or spacecraft. As an example, the system 200 can be included in or correspond to the first aircraft 102 of FIGS. 1A, 1D, and 1E. In the implementation shown in FIG. 2, the system 200 includes an LWIR camera 202, a vision processor 204, an optional embedded GPS-aided inertial navigation system (EGI) 206, a guidance processor 208, an auto pilot system 210, and optional data storage 212. The LWIR camera 202 is coupled to the vision processor 204, the vision processor 204 is coupled to the guidance processor 208 and the data storage 212, the EGI 206 is coupled to the guidance processor 208, and the guidance processor 208 is coupled to the vision processor 204, the EGI 206, and the auto pilot system 210. Although illustrated as being included in the system 200 in FIG. 2, in some other implementations, the EGI 206 is omitted from the system 200.

The LWIR camera 202 may include or correspond to the thermal imaging sensor 104. In some implementations, the LWIR camera 202 is configured to capture thermal images within a field of vision and to output thermal image data representing the thermal images to the vision processor 204. The thermal image data can depict temperature information of a captured scene, such as a portion of another aircraft or spacecraft that is within a particular range of the aircraft on which the system 200 is onboard. Although described as a LWIR camera, in other implementations, the LWIR camera 202 may additionally include, or be replaced with, any type of IR image capture device or thermal imaging device. Additionally, or alternatively, one or more other cameras, image capture devices, LED devices, or the like, may be similarly coupled to the vision processor 204 and configured to output respective image data or other types of data for use by the vision processor 204.

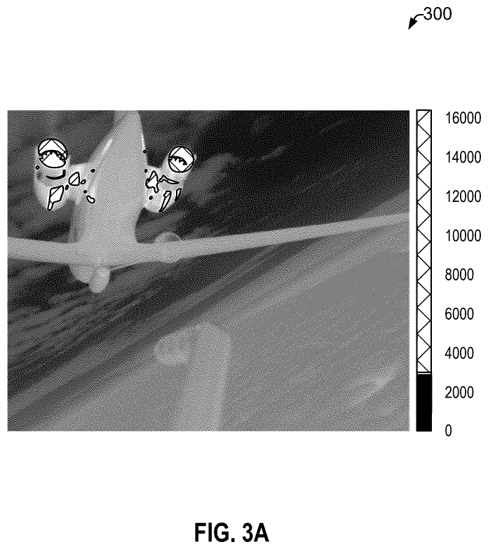

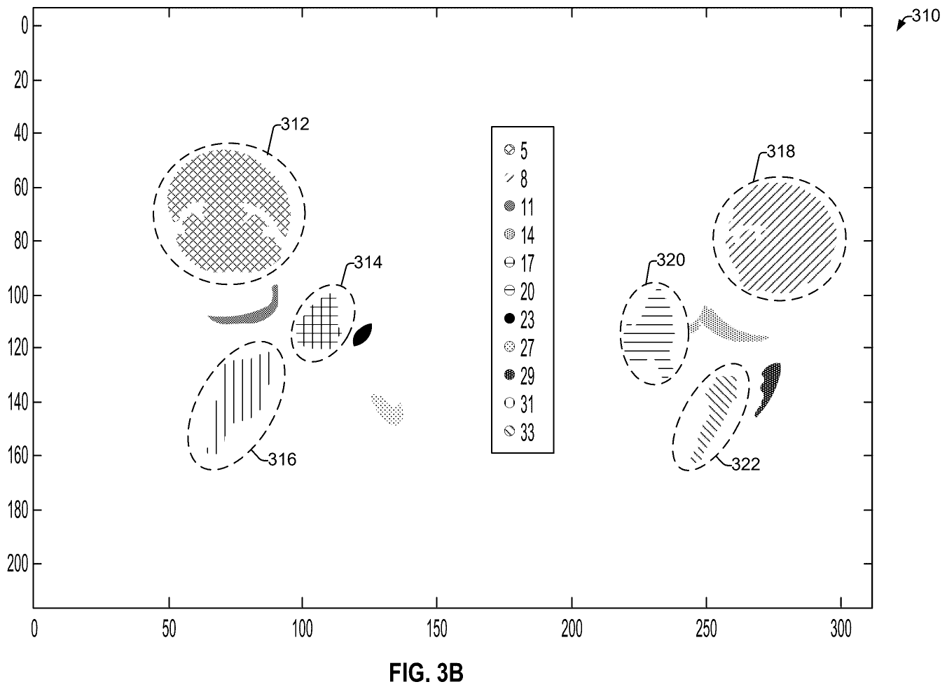

The vision processor 204 includes one or more processors, processor systems, CPUs, GPUs, and/or other hardware or circuitry, such as FPGAs or ASICs, that are configured to process the thermal image data from the LWIR camera 202 (and optionally other data from other sensors) to identify and track another aircraft or spacecraft within a series of thermal images represented by the thermal image data. For example, the vision processor 204 can include or correspond to the vision processor 108. As described further herein with reference to FIGS. 3A, 3B, 4, 5A, 5B, and 6, the vision processor 204 can perform image thresholding to identify regions of interest that correspond to predefined aircraft geometries (e.g., aircrafts with known engine geometries) to estimate a range between the aircraft in which the system 200 is onboard and another aircraft, and optionally position information associated with the other aircraft (e.g., if the vision processor 204 receives position data from the EGI 206 or another component of the system 200). Additionally, in some implementations, the vision processor 204 can process the thermal imaging data and/or other data to identify, track, and/or determine the range to, or position of, another aircraft, or a connector of the other aircraft, using other techniques. In implementations in which the vision processor 204 determines multiple range estimates, position estimates, other derived values, and/or other processed thermal image data, each such estimation or value may be associated with a confidence score generated by the vision processor 204. The vision processor 204 provides the estimates, derived values, and/or processed thermal image data, and optionally the confidence scores, to the guidance processor 208 for further processing and, optionally, to the data storage 212.

The guidance processor 208, the EGI 206, or both, may include or correspond to the additional processor(s) 111. The guidance processor 208 includes one or more processors, processor systems, CPUs, GPUs, and/or other hardware or circuitry, such as FPGAs or ASICs, that are configured to process the output of the vision processor 204 and optional GPS and INS data received from the EGI 206 to determine one or more maneuvers to be performed by the aircraft on which the system 200 is onboard to cause the aircraft to mate a connector (e.g., the probe 106) with a connector (e.g., the drogue 114) of the other aircraft. The maneuvers can include navigation directions for the aircraft, movements for a probe or other arm or boom that controls the connector for the aircraft, engine control instructions, other maneuver-related information, or a combination thereof, that when executed by the auto pilot system 210, cause the aircraft to approach the other aircraft, maintain formation flight with the other aircraft, and/or mate the connector to the corresponding connector of the other aircraft, such as during an aerial refueling operation or a docking operation between spacecraft. As a non-limiting example, the guidance processor 208 may output instructions to the auto pilot system 210 to cause the first aircraft 102 to mate the probe 106 with the drogue 114 of the second aircraft 112.

In implementations that include the data storage 212, the vision processor 204 can be configured to provide the various outputs (e.g., range estimate(s), position estimate(s), tracking information, processed thermal image data, etc.) to the data storage 212 for storage on the aircraft and/or transmission to another system or device. For example, the data storage 212 can include network or cloud storage that is wireless connected to the system 200 at various times. The output data from the vision processor 204 (the “vision output data”) may be used to train one or more artificial intelligence (AI) or machine learning (ML) models to automatically perform operations associated with the vision processor 204, the guidance processor 208, or a combination thereof. To illustrate, the vision output data can be provided as training data to an autonomous agent (e.g., an AI or ML model) to train the autonomous agent to estimate a range to another aircraft based on input thermal imaging data. In a particular aspect, the thresholded image data (or features extracted therefrom) can be labeled with corresponding range estimates, corresponding confidence scores, other intermediate values, or a combination thereof, to train the autonomous agent to estimate a range based on non-labeled thermal image data received as input. In another aspect, the thresholded image data (or features extracted therefrom) can be labeled with one or more maneuvers output by the guidance processor 208 to train the autonomous agent to, responsive to receiving unlabeled thermal image data, output maneuver instructions to cause the aircraft to mate the connector with the connector of the other aircraft. In a particular implementation, the trained autonomous agent includes or corresponds to a neural network. As an example, the neural network of the trained autonomous agent is trained using one or more reinforcement learning techniques. To illustrate, during a training phase, the reinforcement learning techniques may train the neural network based in part on a reward that is determined by comparing a proposed maneuver output by the neural network to an optimum or target maneuver in particular circumstances. In this context, the optimum or target maneuver may include, for example, a shortest or least cost maneuver to mate the connectors of the aircrafts; a maneuver that mimics a maneuver performed by one or more skilled human operators under similar circumstances; a maneuver that satisfies a set of safety conditions, such as not causing any undesired contact between portions of the aircrafts; a maneuver that corresponds to maneuvering characteristics specified during or before training; or a combination thereof. As another example, during a training phase, the reinforcement learning techniques may train the neural network based in part on a reward that is determined by comparing a range estimate or position estimate output by the neural network to a measured range or a measured position of the other aircraft depicted in the thermal image data.

In some implementations, the system 200 may include a display (not shown). The display may be coupled to the LWIR camera 202, the vision processor 204, the guidance processor 208, the auto pilot system 210, or a combination thereof. The display is configured to display one or more images, a representation of one or more operations performed by the vision processor 204, one or more operations performed by guidance processor 208, one or more operations performed by the auto pilot system 210, or a combination thereof.

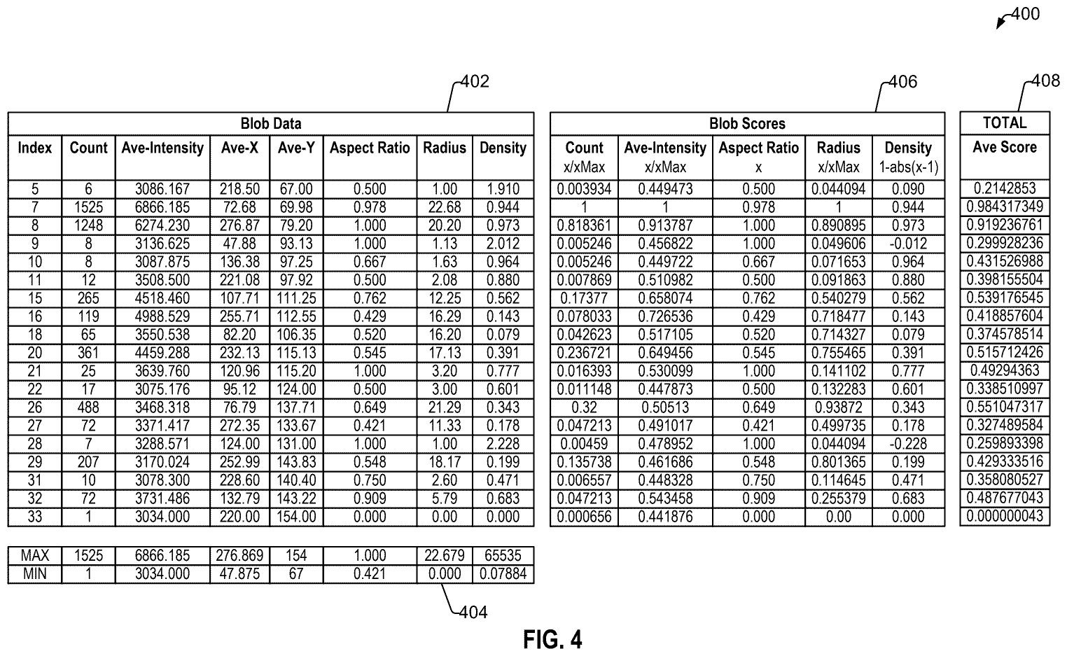

FIG. 3A depicts an example of a thermal image 300 and FIG. 3B depicts an example of a portion of a thresholded thermal image (referred to herein a “thresholded thermal image portion 310”) used to perform thermal image-based tracking to mate connectors of vehicles, and FIG. 4 depicts examples of data tables 400 that include pixel characteristics and scores associated with clusters of pixels of the thresholded thermal image portion 310. The thermal image 300 can be generated by a thermal imaging device, such as the thermal imaging sensor 104 of FIGS. 1A, 1D, and 1E or the LWIR camera 202 of FIG. 2, and the thresholded thermal image portion 310 can be generated, and additional operations described herein with reference to FIGS. 3A, 3B, and 4 can be performed, by a vision processor, such as the vision processor 108 of FIG. 1A or the vision processor 204 of FIG. 2.

The data tables 400 of FIG. 4 include tables for blob data 402, derived values 404, blob scores 406 (e.g., cluster scores), and total scores 408 (e.g., total scores). The blob data 402 includes pixel characteristics associated with clusters (e.g., groups or “blobs”) of pixels in the thresholded thermal image portion 310 of FIG. 3B, and the derived values 404 include values based on or derived from the blob data 402. In the implementation shown in FIG. 4, the blob data 402 includes, for each blob, a blob index (“index”), a count of pixels in the blob (“count”), an average pixel intensity of the blob (“ave-intensity”), an average x-coordinate of pixels in the blob (“ave-x”), an average y-coordinate of pixels in the blob (“ave-y”), an aspect ratio associated with the blob (“aspect ratio”) (e.g., which can indicate cluster circularity), a radius of the blob (“radius”), and a density of the blob (“density”), and the derived values 404 include maximum and minimum values for each of the per-blob values included in the blob data 402 (excluding blob index). The blob scores 406 include, for each blob, a count score (“count”) that represents a fraction (e.g., ratio) of the count of pixels in the blob to the maximum count of pixels included in any blobs, an average intensity score (“ave-intensity”) that represents a fraction of the average pixel intensity of the blob to the maximum average pixel intensity of all the blobs, an aspect ratio score (“aspect ratio”) that represents a fraction of the aspect ratio of the blob to the maximum aspect ratio of all the blobs (e.g., a cluster circularity score), a radius score (“radius”) that represents a fraction of the radius of the blob to the maximum radius of all the blobs, and a density score (“density”) that represents a fraction of the density of the blob to the maximum density of all the blobs. Stated another way, the blob scores 406 represent, for each blob, a comparison of the pixel characteristics (e.g., the count, the average intensity, the aspect ratio, the radius, and the density) to maximum pixel characteristics, or other derived values, for all of the blobs. The total scores 408 include, for each blob, an average (e.g., a weighted average) of the blob scores 406. Although particular pixel characteristics, values, and scores are illustrated in FIG. 4, this example is not limiting, and in other implementations, different pixel characteristics, values, and/or scores may be extracted, derived, or generated from thresholded thermal images to generate the data tables 400.

Aspects of this disclosure describe systems and methods that provide a passive solution to aircraft or spacecraft tracking using a thermal imaging sensor (e.g., a camera) and a vision processor that, depending on engine geometry of other aircraft, can provide a range estimate and/or a position estimate similar to GPS but that is immune to almost all other interference, other than the sun or nearby aircraft, unlike GPS-based systems. In some particular implementations, the thermal image-based tracking operates in the context of, or taking as assumptions, the existence of a thermal imaging sensor (e.g., the thermal imaging sensor 104 or the LWIR camera 202) on a first aircraft (e.g., the first aircraft 102), a second aircraft (e.g., the second aircraft 112) in front of the first aircraft with either two or more jet engines as the primary means of propulsion (or a linear ducted jet exhaust with less than four-fold symmetry), a predefined geometry of the engines of the second aircraft (e.g., a rough geometric idea of what the engines on the second aircraft are expected to look like for the particular aircraft type), optionally position information (e.g., six degree of freedom (6DoF) position information) of the first aircraft as well as an estimated time and date, and a computer system (e.g., a vision processor) configured to perform at least basic image processing functionality.

The above-described systems, such as the system 100 of FIGS. 1A-E and the system 200 of FIG. 2, may perform thermal image-based tracking by receiving a thermal image (e.g., a portion of thermal image data) and thresholding the thermal image to extract any objects other than hot engine exhaust. For example, the vision processor 108 or the vision processor 204 performs thresholding on the thermal image 300 of FIG. 3A to generate the thresholded thermal image portion 310 of FIG. 3B. The thresholded thermal image portion 310 includes pixels having pixel intensities that satisfy (e.g., are greater than or equal to, or are greater than) a threshold. To illustrate, the thermal image 300 measures a relative thermal signature of a scene in front of the first aircraft, and the thresholded thermal image portion 310 removes the background and isolates the tanker engines (and any similar temperature areas). The threshold may be predefined or adaptively determined, such as based on a percentage of pixels to threshold from the thresholded thermal image portion 310. In implementations, thresholding a thermal image captured from the front of the first aircraft has a high likelihood of depicting the engines of the second aircraft in situations in which the following assumptions are true: other than the sun, no objects naturally in the sky should be as hot as the engines of a nearby tanker aircraft (e.g., the second aircraft); the first aircraft only attempts to join with a tanker aircraft (e.g., the second aircraft) that has a similar heading and bank angle; the location of the sun in the sky can be known from the date, the time, and the position of the first aircraft, such that the sun can effectively be masked in thermal images; and two or more engines are present in the captured thermal image frames or a single engine has a clear extend and/or asymmetry that can be leveraged to estimate the position of the second aircraft.

After generating the thresholded thermal image portion 310, the vision processor 108 or the vision processor 204 isolates the thresholded thermal image portion 310 into one or more engine-shaped regions of interest. Stated another way, the pixels of the thresholded thermal image portion 310 may be clustered into one or more clusters or groups, referred to herein as “blobs”, based on similarity of pixel characteristics. One or more of the blobs can be identified as regions of interest that correspond to engines or engine exhaust. To illustrate, the pixels in the thresholded thermal image portion 310 may be clustered into blobs based on similarities in the pixel characteristics represented by the blob data 402. The clustering may be performed using any clustering algorithm, such as k-means clustering as a non-limiting example. As an illustrative example, in FIG. 3B, some of the blobs that are identified via performance of the clustering include a first blob 312, a second blob 314, a third blob 316, a fourth blob 318, a fifth blob 320, and a sixth blob 322, in addition to other blobs not identified in FIG. 3B.

After grouping the pixels of the thresholded thermal image portion 310 into one or more clusters (e.g., the blobs represented by the blob data 402, including the blobs 312-322) based on similarities between the pixel characteristics, the derived values 404 may be computed, and the blob data 402 and the derived values 404 may be used to generate the blob scores 406. After generating the blob scores 406, the total scores 408 may be generated based on the blob scores 406. Although described as separate scores, the blob scores 406 can be intermediate scores determined as part of the process to generate the total scores 408. Alternatively, a different technique for aggregating the blob scores 406 to generate the total scores 408 is used in some other implementations, such as selecting the blob having the most maximum scores of the blob scores 406, as a non-limiting example. The vision processor 108 or the vision processor 204 identifies at least one of the blobs as the region(s) of interest based on the total scores 408. In the example depicted in FIGS. 3A, 3B, and 4, the first blob 312 and the fourth blob 318 are identified based on these two blobs having the highest scores of the total scores 408. Alternatively, the region(s) of interest can be identified based on the corresponding total scores satisfying a threshold, based on the total scores being sufficiently similar (e.g., within a threshold range), using other techniques, or any combination thereof.

After selecting one or more of the blobs as regions of interest corresponding to engines (e.g., engine regions), the vision processor 108 or the vision processor 204 determines a centroid and axis of each of the engine regions. In the example shown in FIG. 3B, the vision processor 108 or the vision processor 204 determines a first centroid of the first blob 312 and a first axis through the first blob 312 (e.g., an axis of orientation and/or a roll, pitch, and/or yaw axis). Similarly, the vision processor 108 or the vision processor 204 determines a second centroid of the fourth blob 318 and a second axis through the fourth blob 318. After calculating the centroids and the axes for the blobs 312 and 318, the centroids and the blobs (e.g., an engine signature derived from the thresholded thermal image portion 310) can be matched to a known engine geometry of a type of aircraft associated with the second aircraft. For example, the engine signature derived from the thresholded thermal image portion 310 can be used to select an aircraft geometry (e.g., an engine geometry) from a group of predefined aircraft geometries that matches, or is most similar to, the engine signature. In some implementations, the engine signature may be adjusted to compensate for the pitch, roll, and/or yaw of the first aircraft and/or for the frame position of the thermal imaging sensor prior to using the engine signature to select the aircraft geometry from the group of predefined aircraft geometries. For example, an axis through the first centroid and the second centroid may be generated, and the thresholded thermal image portion 310 may be rotated based on the pitch, roll, and/or yaw of the first aircraft such that the axis between the two centroids matches an orientation of the predefined aircraft geometries.

After selecting the aircraft geometry based on the engine signature derived from the thresholded thermal image portion 310, the vision processor 108 or the vision processor 204 determines the range from the first aircraft to the second aircraft based on a pixel distance between the regions of interest (e.g., the blobs 312 and 318) in the thresholded thermal image portion 310 and the selected aircraft geometry. For example, the engine pixels can be determined according to Equation 1 below, and the range can be determined according to Equation 2 below:

$$\sqrt{{( \overline{{X}_{1}} - \overline{{X}_{2}} )}^{2} + {( {\overline{Y}}_{1} - {\overline{Y}}_{2} )}^{2}} \qquad Equation 1$$

$$Range = \frac{KnownEngineDistance}{2} / tan ( \frac{EnginePixels * iFOV}{2} ) \qquad Equation 2$$

Where X̅₁ is the average x-coordinate of pixels in the first blob 312, Y̅₁ is the average y-coordinate of pixels in the first blob 312, X̅₂ is the average x-coordinate of pixels in the fourth blob 318, Y̅₂ is the average y-coordinate of pixels in the fourth blob 318, KnownEngineDistance is a distance from the aircraft geometry (e.g., from a computer aided design (CAD) model or other model of the aircraft), and iFOV is the camera field of view per pixel. Stated another way, the estimated range can be based on pixel coordinates (e.g., average x-coordinates and average y-coordinates) of the two blobs (e.g., regions of interest), an engine distance (e.g., a distance between two engines) associated with a selected aircraft geometry, and optionally, a field of view of the thermal imaging sensor (e.g., the camera). In some implementations, the vision processor 108 or the vision processor 204 also determines a position of the second aircraft based on a position of the device, a field of view of the thermal imaging sensor, a relative position of the thermal imaging sensor with respect to the device, or a combination thereof, such as by applying a geometric lever-arm conversion using the 6DoF position of the first aircraft to estimate the position of the second aircraft and/or the connector (e.g., a drogue) of the second aircraft.

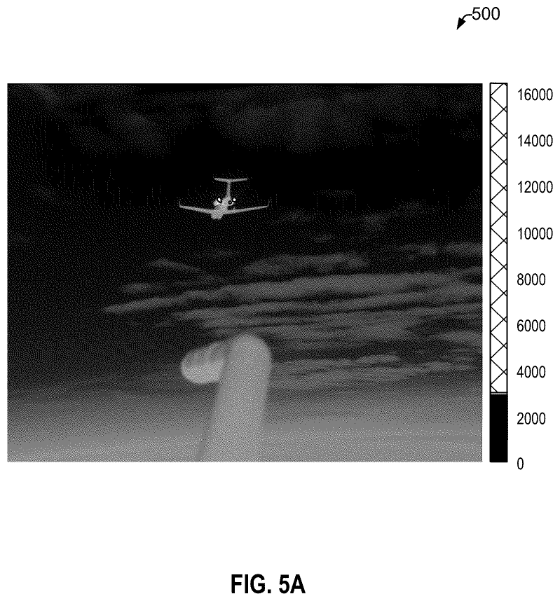

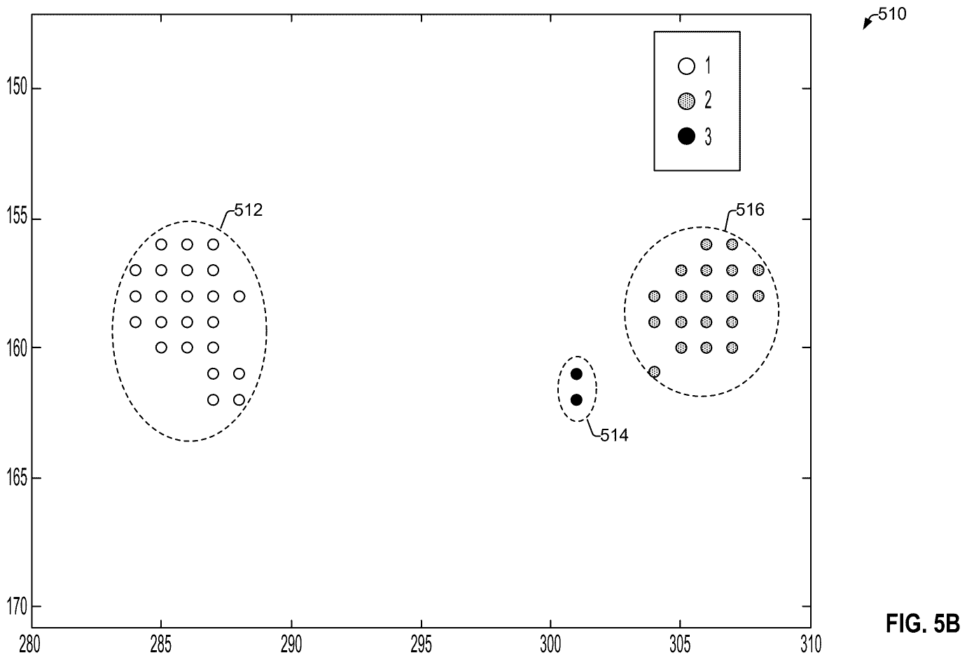

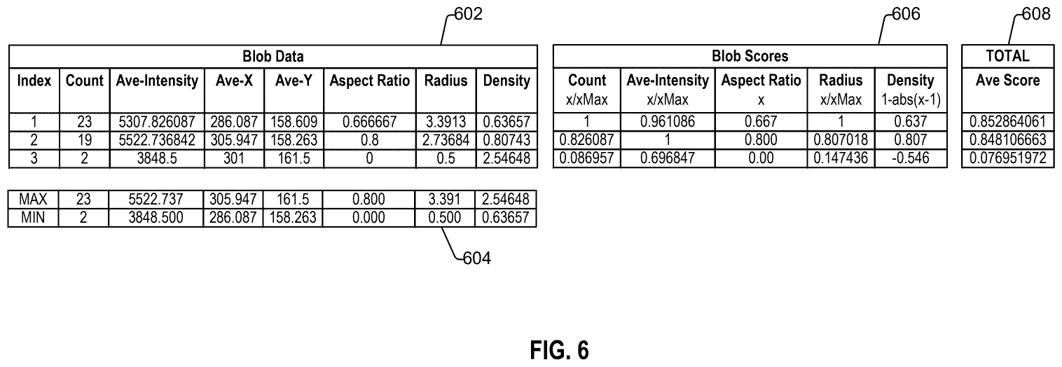

FIG. 5A depicts an example of a thermal image 500 and FIG. 5B depicts an example of a thresholded thermal image 510 used to perform thermal image-based tracking to mate connectors of vehicles, and FIG. 6 depicts examples of data tables 600 that include pixel characteristics and scores associated with clusters of pixels of the thresholded thermal image 510. The thermal image 500 of FIG. 5A can be generated by a thermal imaging device, such as the thermal imaging sensor 104 of FIGS. 1A, 1D, and 1E or the LWIR camera 202 of FIG. 2, and the thresholded thermal image 510 of FIG. 5B can be generated, and additional operations described herein with reference to FIGS. 5A, 5B, and 6 can be performed, by a vision processor, such as the vision processor 108 of FIG. 1A or the vision processor 204 of FIG. 2.

The data tables 600 of FIG. 6 include tables for blob data 602, derived values 604, blob scores 606, and total scores 608. The blob data 602 includes pixel characteristics associated with clusters (e.g., groups or “blobs”) of pixels in the thresholded thermal image 510 of FIG. 5B, the derived values 604 include values based on or derived from the blob data 602, the blob scores 606 include, for each blob, scores based on the blob data 602 and the derived values 604, and the total scores 608 include, for each blob, an average (e.g., a weighted average) of each of the blob scores 606. In the implementation shown in FIG. 6, the blob data 602, the derived values 604, the blob scores 606, and the total scores 608 include the same pixel characteristics, values, and scores as described above with reference to FIG. 4. Although particular pixel characteristics, values, and scores are illustrated in FIG. 6, this example is not limiting, and in other implementations, different pixel characteristics, values, and/or scores may be extracted, derived, or generated from thresholded thermal images to generate the data tables 600.

FIGS. 5A, 5B, and 6 depict an example in which the second aircraft is farther away from the first aircraft than the example depicted in FIGS. 3A, 3B, and 4. In some implementations, the difficulty of identifying the correct aircraft geometry is inversely proportional to the distance between the two aircraft. To illustrate, the thresholded thermal image 510 of FIG. 5B includes fewer pixels that satisfy the threshold than the thresholded thermal image portion 310 of FIG. 3B due to the increased range between the two aircraft resulting in reduced areas in images corresponding to the thermal exhaust of the engines of the second aircraft. Similar to as described above, the thresholded thermal image 510 may be processed to cluster the pixels into one or more blobs (e.g., clusters or groups), such as a first blob 512, a second blob 514, and a third blob 516, which are represented by the blob data 602. The first blob 512 and the third blob 516 can be identified as the engine regions based on the total scores 608, similar to as described above for FIGS. 3A, 3B, and 4.

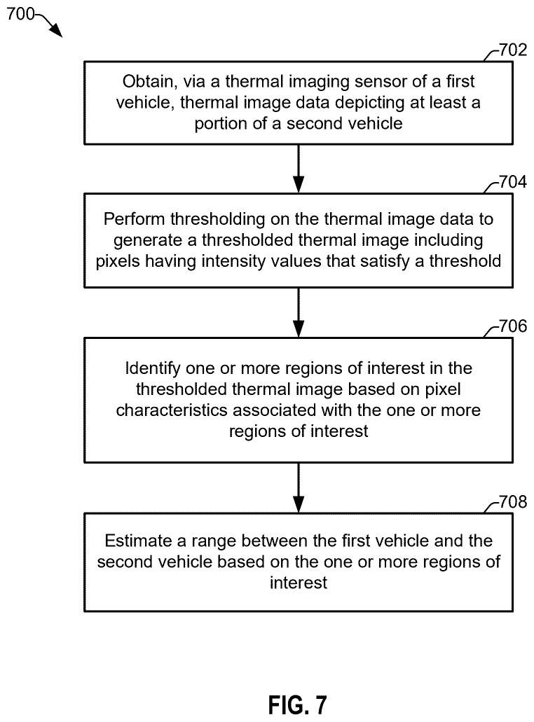

FIG. 7 is a flowchart that illustrates an example of a method 700 of performing thermal image-based tracking to mate connectors of vehicles according to one or more aspects of the present disclosure. The method 700 can be initiated, performed, or controlled by one or more processors executing instructions, or by circuitry configured to cause performance of one or more operations, such as resides within the vision processor 108 of FIG. 1A, the vision processor 204 of FIG. 2, or a combination thereof.

In some implementations, the method 700 includes, at block 702, obtaining, via a thermal imaging sensor of a first vehicle, thermal image data depicting at least a portion of a second vehicle. For example, the thermal imaging sensor 104 of FIGS. 1A, 1D, and 1E or the LWIR camera 202 of FIG. 2 can generate thermal image data depicting at least a portion of the second aircraft 112 of FIG. 1A, which can be received by the vision processor 108 of FIG. 1A or the vision processor 204 of FIG. 2. The method 700 also includes, at block 704, performing, at the first vehicle, thresholding on the thermal image data to generate a thresholded thermal image including pixels having intensity values that satisfy a threshold. For example, the vision processor 108 of FIG. 1A or the vision processor 204 of FIG. 2 can perform thresholding on thermal image data to generate a thresholded thermal image, such as the thresholded thermal image portion 310 of FIG. 3B or the thresholded thermal image 510 of FIG. 5B.

The method 700 includes, at block 706, identifying one or more regions of interest in the thresholded thermal image based on pixel characteristics associated with the one or more regions of interest. For example, the vision processor 108 of FIG. 1A or the vision processor 204 of FIG. 2 can identify regions of interest in thresholded thermal images, such as the first blob 312 and the fourth blob 318 of FIG. 3B or the first blob 512 and the third blob 516 of FIG. 5B. In some implementations, the portion of the vehicle includes one or more engines of the vehicle, and the one or more regions of interest correspond to the one or more engines or engine exhaust. The method 700 includes, at block 708, estimating a range between the first vehicle and the second vehicle based on the one or more regions of interest. For example, the vision processor 108 of FIG. 1A or the vision processor 204 of FIG. 2 can determine a range between the first aircraft 102 and the second aircraft 112 of FIG. 1A based on the identified regions of interest.

In some implementations, the method 700 can include more, fewer, and/or different steps without departing from the scope of the subject disclosure. For example, the method 700 can also include, to identify the one or more regions of interest, grouping pixels in the thresholded thermal image into one or more clusters based on similarities between the pixel characteristics, generating cluster scores for the one or more clusters based on the corresponding pixel characteristics, and identifying at least one of the one or more clusters as the one or more regions of interest based on the cluster scores. For example, the one or more clusters may include or correspond to the blobs 312-322 of FIG. 3B, the pixel characteristics may include or correspond to the blob data 402 of FIG. 4, and the cluster scores may include or correspond to the blob scores 406, the total scores 408, or both, of FIG. 4. The pixel characteristics can include pixel count, intensity value, cluster circularity (e.g., as indicated by aspect ratios of the clusters), cluster size, cluster density, or a combination thereof. In some such implementations, a first cluster score (e.g., a first blob score) of the one or more clusters is based on a comparison of the pixel characteristics (e.g., the blob data 402) of the first cluster and maximum pixel characteristics (e.g., the derived values 404) of the one or more clusters. As another example, the one or more regions of interest can include multiple (e.g., a pair or more) regions of interest, and the method 700 can also include determining centroids of the multiple regions of interest, determining an axis for each of the multiple regions of interest, selecting a vehicle geometry from a group of predefined vehicle geometries based on the centroids and the axis for each of the multiple regions of interest, and estimating the range based on selected vehicle geometry. In some such examples, the range is based on pixel coordinates of the multiple regions of interest and a distance between engines associated with the selected vehicle geometry. As another example, the one or more regions of interest can include a single region of interest, and the method 700 can also include determining a centroid of the single region of interest, determining a size of the single region of interest, determining an axis of the single region of interest, selecting a vehicle geometry from a group of predefined vehicle geometries based on the centroid, the size, and the axis, and estimating the range based on selected vehicle geometry. Additionally, or alternatively, the method 700 can include determining a position of the vehicle based on a position of the device, a field of view of the thermal imaging sensor, a relative position of the thermal imaging sensor with respect to the device, or a combination thereof.

The method described above with reference to FIG. 7 can be implemented to realize one or more of the technical advantages described in more detail above. For example, the method 700 can improve efficiency (e.g., by reducing training costs), reliability, and repeatability of operations to mate connectors between two vehicles (e.g., autonomous vehicles), such as during complicated maneuvers such as aerial refueling operations or docking operations. For example, by processing the thermal image data generated by the thermal imaging sensor to determine a range between the device (e.g., the first aircraft 102 of FIGS. 1A, 1D, and 1E) and the aircraft (e.g., the second aircraft 112 of FIG. 1A) avoids the cost and complexity of integrating other types of sensors such as GPS-based or INS-based systems, or the estimated range can be used in combination with such systems to provide improved reliability and confidence in the estimates. Such highly reliable estimates are provided without significantly increasing the cost or complexity of the device due to the relatively low cost and complexity of hardware to support the thermal imaging sensing operations and the vision processing operations of the method 700. The estimates generated by the method 700 may be provided to additional processor(s), such as a guidance processor, that can mimic maneuvers performed by highly skilled human operators without the time and cost required to train the operators.

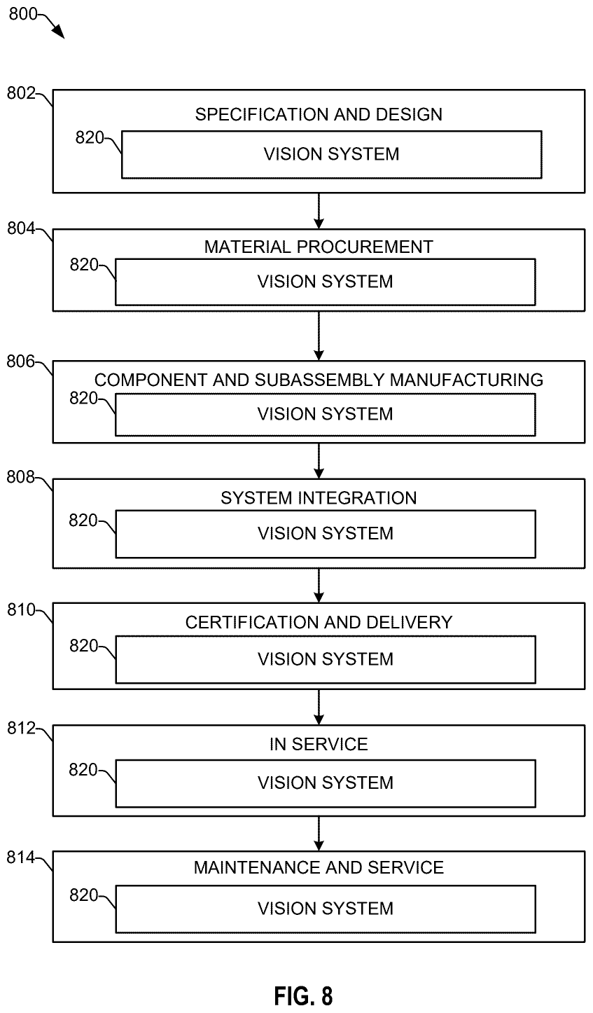

Referring to FIG. 8, a flowchart illustrative of an example of a life cycle of an aircraft that includes a vision system configured to perform thermal image-based tracking to mate connectors of vehicles is shown and designated 800. During pre-production, the exemplary method 800 includes, at 802, specification and design of an aircraft, such as the first aircraft 102 described with reference to FIGS. 1A, 1D, and 1E. During specification and design of the aircraft, the method 800 can include specification and design of a vision system 820 that is configured to perform thermal image-based tracking to mate connectors of vehicles. The vision system 820 may include one or more components of the system 100 of FIGS. 1A-1E (e.g., the thermal imaging sensor 104, the vision processor 108, and/or the one or more additional processor(s) 111) or the system 200 of FIG. 2. At 804, the method 800 includes material procurement, which can include procuring materials for the vision system 820.

During production, the method 800 includes, at 806, component and subassembly manufacturing and, at 808, system integration of the aircraft. For example, the method 800 can include component and subassembly manufacturing of the vision system 820 and system integration of the vision system 820. At 810, the method 800 includes certification and delivery of the aircraft and, at 812, placing the aircraft in service. Certification and delivery can include certification of the vision system 820 to place the vision system 820 in service. While in service by a customer, the aircraft can be scheduled for routine maintenance and service (which can also include modification, reconfiguration, refurbishment, and so on). At 814, the method 800 includes performing maintenance and service on the aircraft, which can include performing maintenance and service on the vision system 820.

Each of the processes of the method 800 can be performed or carried out by a system integrator, a third party, and/or an operator (e.g., a customer). For the purposes of this description, a system integrator can include without limitation any number of aircraft manufacturers and major-system subcontractors; a third party can include without limitation any number of venders, subcontractors, and suppliers; and an operator can be an airline, leasing company, military entity, service organization, and so on.

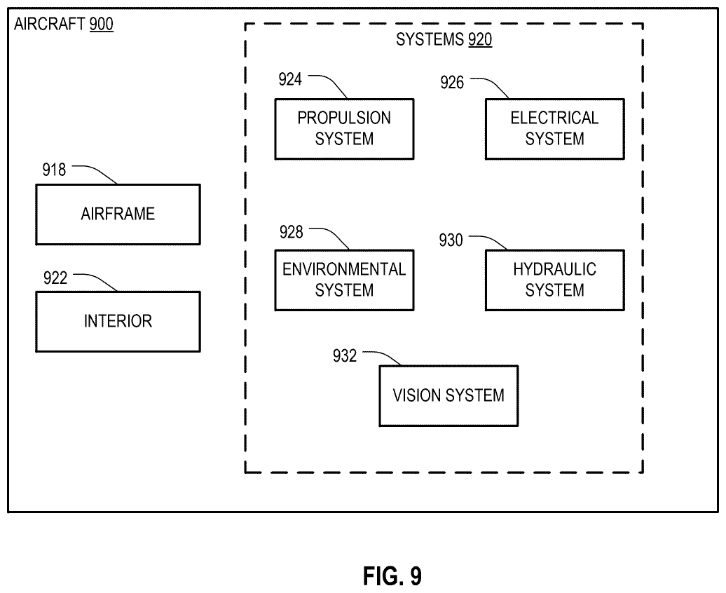

Aspects of the disclosure can be described in the context of an example of a vehicle. A particular example of a vehicle is an aircraft 900 as shown in FIG. 9. The aircraft 900 can be a drone aircraft or any type of autonomous or semi-autonomous aircraft or spacecraft. In the example of FIG. 9, the aircraft 900 includes an airframe 918 with a plurality of systems 920 and an interior 922. Examples of the plurality of systems 920 include one or more of a propulsion system 924, an electrical system 926, an environmental system 928, a hydraulic system 930, and a vision system 932. Any number of other systems can be included and/or one or more of the systems depicted in FIG. 9 may be omitted. In the example of FIG. 9, the vision system 932 is configured to provide thermal image-based tracking functionality to mate connectors of vehicles and can include or correspond to the system 100 of FIGS. 1A-1E, the system 200 of FIG. 2, the vision system 820 of FIG. 8, or any combination thereof.

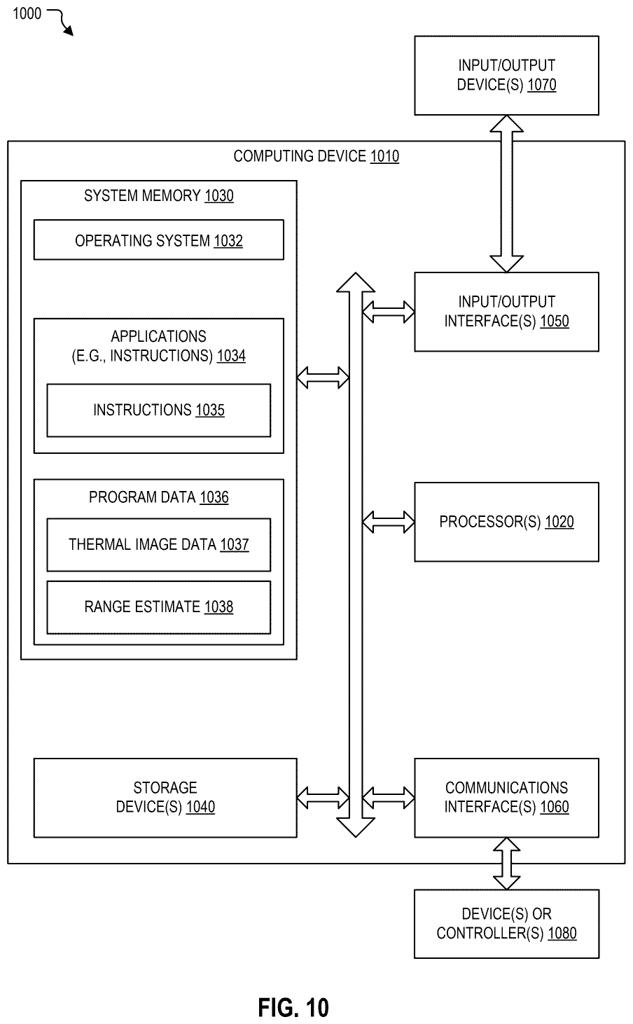

FIG. 10 is a block diagram of a computing environment 1000 including a computing device 1010 configured to support aspects of computer-implemented methods and computer-executable program instructions (or code) according to the present disclosure. For example, the computing device 1010, or portions thereof, is configured to execute instructions to initiate, perform, or control one or more operations described with reference to FIGS. 1A-1E, 2, 3A, 3B, 4, 5A, 5B, and 6-9.

The computing device 1010 includes one or more processors 1020. The processor(s) 1020 are configured to communicate with system memory 1030, one or more storage devices 1040, one or more input/output interfaces 1050, one or more communications interfaces 1060, or any combination thereof. The system memory 1030 includes volatile memory devices (e.g., random access memory (RAM) devices), nonvolatile memory devices (e.g., read-only memory (ROM) devices, programmable read-only memory, and flash memory), or both. The system memory 1030 stores an operating system 1032, which can include a basic input/output system for booting the computing device 1010 as well as a full operating system to enable the computing device 1010 to interact with users, other programs, and other devices. The system memory 1030 stores system (program) data 1036, such as thermal image data 1037, a range estimate 1038, or a combination thereof. The thermal image data 1037 can include or correspond to thermal image data generated by the thermal image sensor 104 of FIGS. 1A, 1D, and 1E or the LWIR camera 202 of FIG. 2. The range estimate 1038 can include or correspond to a range estimate generated by the vision processor 108 of FIG. 1A or the vision processor 204 of FIG. 2.

The system memory 1030 includes one or more applications 1034 (e.g., sets of instructions) executable by the processor(s) 1020. As an example, the one or more applications 1034 include instructions executable by the processor(s) 1020 to initiate, control, or perform one or more operations described with reference to FIGS. 1A-1E, 2, 3A, 3B, 4, 5A, 5B, and 6-10. To illustrate, the one or more applications 1034 include instructions 1035 executable by the processor(s) 1020 to initiate, control, or perform one or more operations described with reference to the vision processor 108 of FIG. 1A, the vision processor 204 of FIG. 2, or a combination thereof.

In a particular implementation, the system memory 1030 includes a non-transitory, computer readable medium storing the instructions 1035 that, when executed by the processor(s) 1020, cause the processor(s) 1020 to initiate, perform, or control operations to perform thermal image-based tracking functionality to mate connectors of vehicles. The operations include performing thresholding on thermal image data to generate a thresholded thermal image including pixels having intensity values that satisfy a threshold. The thermal image data depicts at least a portion of a vehicle. The operations also include identifying one or more regions of interest in the thresholded thermal image based on pixel characteristics associated with the one or more regions of interest. The operations further include estimating a range between the device and the vehicle based on the one or more regions of interest.

The one or more storage devices 1040 include nonvolatile storage devices, such as magnetic disks, optical disks, or flash memory devices. In a particular example, the storage devices 1040 include both removable and non-removable memory devices. The storage devices 1040 are configured to store an operating system, images of operating systems, applications (e.g., one or more of the applications 1034), and program data (e.g., the system program data 1036). In a particular aspect, the system memory 1030, the storage devices 1040, or both, include tangible computer-readable media. In a particular aspect, one or more of the storage devices 1040 are external to the computing device 1010.

The one or more input/output interfaces 1050 enable the computing device 1010 to communicate with one or more input/output devices 1070 to facilitate user interaction. For example, the one or more input/output interfaces 1050 can include a display interface, an input interface, or both. For example, the input/output interface 1050 is adapted to receive input from a user, to receive input from another computing device, or a combination thereof. In some implementations, the input/output interface 1050 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 1070 includes one or more user interface devices and displays, including some combination of buttons, keyboards, pointing devices, displays, speakers, microphones, touch screens, and other devices.

The processor(s) 1020 are configured to communicate with devices or controllers 1080 via the one or more communications interfaces 1060. For example, the one or more communications interfaces 1060 can include a network interface. The devices or controllers 1080 can include, for example, a controller for the probe 106, one or more other devices, or any combination thereof.

In some implementations, a non-transitory, computer readable medium stores instructions that, when executed by one or more processors, cause the one or more processors to initiate, perform, or control operations to perform part or all of the functionality described above. For example, the instructions can be executable to implement one or more of the operations or methods of FIGS. 1A-1E, 2, 3A, 3B, 4, 5A, 5B, and 6-10. In some implementations, part or all of one or more of the operations or methods of FIGS. 1A-1E, 2, 3A, 3B, 4, 5A, 5B, and 6-10 can be implemented by one or more processors (e.g., one or more central processing units (CPUs), one or more graphics processing units (GPUs), one or more digital signal processors (DSPs), one or more field-programmable gate arrays (FPGAs), or one or more application-specific integrated circuits (ASICs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Aspects of the disclosure are described further with reference to the following set of interrelated examples:

According to Example 1, a device includes a thermal imaging sensor and a vision processor. The thermal imaging sensor is configured to generate thermal image data depicting at least a portion of a vehicle. The vision processor is configured to: perform thresholding on the thermal image data to generate a thresholded thermal image including pixels having intensity values that satisfy a threshold; identify one or more regions of interest in the thresholded thermal image based on pixel characteristics associated with the one or more regions of interest; and estimate a range between the device and the vehicle based on the one or more regions of interest.

Example 2 includes the device of Example 1, wherein, to identify the one or more regions of interest, the vision processor is further configured to group pixels in the thresholded thermal image into one or more clusters based on similarities between the pixel characteristics; generate cluster scores for the one or more clusters based on the corresponding pixel characteristics; and identify at least one of the one or more clusters as the one or more regions of interest based on the cluster scores.

Example 3 includes the device of Example 2, wherein the pixel characteristics include pixel count, intensity value, cluster circularity, cluster size, cluster density, or a combination thereof.

Example 4 includes the device of Example 2 or Example 3, where a first cluster score of a first cluster of the one or more clusters is based on a comparison of the pixel characteristics of the first cluster and maximum pixel characteristics of the one or more clusters.

Example 5 includes the device of any of Examples 2 to 4, where the one or more regions of interest include multiple regions of interest, and where the vision processor is further configured to: determine centroids of the multiple regions of interest; determine an axis for each of the multiple regions of interest; select a vehicle geometry from a group of predefined vehicle geometries based on the centroids and the axis for each of the multiple regions of interest; and estimate the range based on selected vehicle geometry.

Example 6 includes the device of Example 5, where the range is based on pixel coordinates of the multiple regions of interest and a distance between engines associated with the selected vehicle geometry.

Example 7 includes the device of any of Examples 2 to 4, where the one or more regions of interest include a single region of interest, and where the vision processor is further configured to: determine a centroid of the single region of interest; determine a size of the single region of interest; determine an axis of the single region of interest; select a vehicle geometry from a group of predefined vehicle geometries based on the centroid, the size, and the axis; and estimate the range based on selected vehicle geometry.

Example 8 includes the device of any of Examples 1 to 7, wherein the vision processor is further configured to determine a position of the vehicle based on a position of the device, a field of view of the thermal imaging sensor, a relative position of the thermal imaging sensor with respect to the device, or a combination thereof.

Example 9 includes the device of any of Examples 1 to 8, where the portion of the vehicle includes one or more engines of the vehicle, and where the one or more regions of interest correspond to the one or more engines or engine exhaust.

According to Example 10, a method includes: performing, by one or more processors of a first vehicle, thresholding on thermal image data to generate a thresholded thermal image including pixels having intensity values that satisfy a threshold, the thermal image data depicting at least a portion of a second vehicle; identifying, by the one or more processors, one or more regions of interest in the thresholded thermal image based on pixel characteristics associated with the one or more regions of interest; and estimating, by the one or more processors, a range between the first vehicle and the second vehicle based on the one or more regions of interest.

Example 11 includes the method of Example 10, further including obtaining, via a thermal imaging sensor of the first vehicle, the thermal image data.

Example 12 includes the method of Example 10 or Example 11, further including: grouping, by the one or more processors, pixels in the thresholded thermal image into one or more clusters based on similarities between the pixel characteristics; generating, by the one or more processors, cluster scores for the one or more clusters based on the corresponding pixel characteristics; and identifying, by the one or more processors, at least one of the one or more clusters as the one or more regions of interest based on the cluster scores.

Example 13 includes the method of Example 12, where the pixel characteristics include pixel count, intensity value, cluster circularity, cluster size, cluster density, or a combination thereof.

Example 14 includes the method of Example 12 or Example 13, further including: determining, by the one or more processors, centroids of multiple regions of interest, wherein the one or more regions of interest include the multiple regions of interest; determining, by the one or more processors, an axis for each of the multiple regions of interest; selecting, by the one or more processors, a vehicle geometry from a group of predefined vehicle geometries based on the centroids and the axis for each of the multiple regions of interest; and estimating, by the one or more processors, the range based on selected vehicle geometry.

Example 15 includes the method of any of Examples 10 to 14, further including determining, by the one or more processors, a position of the second vehicle based on a position of the first vehicle, a field of view of a thermal imaging sensor of the first vehicle, a relative position of the thermal imaging sensor with respect to the first vehicle, or a combination thereof.

Example 16 includes the method of any of Examples 10 to 15, where the portion of the second vehicle includes one or more engines of the second vehicle, and where the one or more regions of interest correspond to the one or more engines or engine exhaust.

According to Example 17, a non-transitory, computer readable medium stores instructions that, when executed by one or more processors, cause the one or more processors to perform operations including: performing, at a first vehicle, thresholding on thermal image data to generate a thresholded thermal image including pixels having intensity values that satisfy a threshold, the thermal image data depicting at least a portion of a second vehicle; identifying one or more regions of interest in the thresholded thermal image based on pixel characteristics associated with the one or more regions of interest; and estimating a range between the first vehicle and the second vehicle based on the one or more regions of interest.

Example 18 includes the non-transitory, computer readable medium of Example 17, where the operations further include grouping pixels in the thresholded thermal image into one or more clusters based on similarities between the pixel characteristics.

Example 19 includes the non-transitory, computer readable medium of Example 18, where the pixel characteristics include pixel count, intensity value, cluster circularity, cluster size, cluster density, or a combination thereof.

Example 20 includes the non-transitory, computer readable medium of any of Examples 17 to 19, where the operations further include determining a position of the second vehicle based on a position of the first vehicle, a field of view of a thermal imaging sensor of the first vehicle, a relative position of the thermal imaging sensor with respect to the first vehicle, or a combination thereof.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A device comprising:
a thermal imaging sensor configured to generate thermal image data depicting at least a portion of a vehicle; and
a vision processor coupled to the thermal imaging sensor, wherein the vision processor is configured to:
perform thresholding on the thermal image data to generate a thresholded thermal image including pixels having intensity values that satisfy a threshold;
identify one or more regions of interest in the thresholded thermal image based on pixel characteristics associated with the one or more regions of interest; and
estimate a range between the device and the vehicle based on the one or more regions of interest.

2. The device of claim 1, wherein, to identify the one or more regions of interest, the vision processor is further configured to:
group pixels in the thresholded thermal image into one or more clusters based on similarities between the pixel characteristics;
generate cluster scores for the one or more clusters based on the corresponding pixel characteristics; and
identify at least one of the one or more clusters as the one or more regions of interest based on the cluster scores.

3. The device of claim 2, wherein the pixel characteristics include pixel count, intensity value, cluster circularity, cluster size, cluster density, or a combination thereof.

4. The device of claim 2, wherein a first cluster score of a first cluster of the one or more clusters is based on a comparison of the pixel characteristics of the first cluster and maximum pixel characteristics of the one or more clusters.

5. The device of claim 2, wherein the one or more regions of interest include multiple regions of interest, and wherein the vision processor is further configured to:
determine centroids of the multiple regions of interest;
determine an axis for each of the multiple regions of interest;
select a vehicle geometry from a group of predefined vehicle geometries based on the centroids and the axis for each of the multiple regions of interest; and
estimate the range based on selected vehicle geometry.

6. The device of claim 5, wherein the range is based on pixel coordinates of the multiple regions of interest and a distance between engines associated with the selected vehicle geometry.

7. The device of claim 2, wherein the one or more regions of interest include a single region of interest, and wherein the vision processor is further configured to:
determine a centroid of the single region of interest;
determine a size of the single region of interest;
determine an axis of the single region of interest;
select a vehicle geometry from a group of predefined vehicle geometries based on the centroid, the size, and the axis; and
estimate the range based on selected vehicle geometry.

8. The device of claim 1, wherein the vision processor is further configured to determine a position of the vehicle based on a position of the device, a field of view of the thermal imaging sensor, a relative position of the thermal imaging sensor with respect to the device, or a combination thereof.

9. The device of claim 1, wherein the portion of the vehicle includes one or more engines of the vehicle, and wherein the one or more regions of interest correspond to the one or more engines or engine exhaust.

10. A method comprising:
performing, by one or more processors of a first vehicle, thresholding on thermal image data to generate a thresholded thermal image including pixels having intensity values that satisfy a threshold, the thermal image data depicting at least a portion of a second vehicle;
identifying, by the one or more processors, one or more regions of interest in the thresholded thermal image based on pixel characteristics associated with the one or more regions of interest; and
estimating, by the one or more processors, a range between the first vehicle and the second vehicle based on the one or more regions of interest.

11. The method of claim 10, further comprising:
obtaining, via a thermal imaging sensor of the first vehicle, the thermal image data.

12. The method of claim 10, wherein identifying the one or more regions of interest comprises:
grouping, by the one or more processors, pixels in the thresholded thermal image into one or more clusters based on similarities between the pixel characteristics;
generating, by the one or more processors, cluster scores for the one or more clusters based on the corresponding pixel characteristics; and
identifying, by the one or more processors, at least one of the one or more clusters as the one or more regions of interest based on the cluster scores.

13. The method of claim 12, wherein the pixel characteristics include pixel count, intensity value, cluster circularity, cluster size, cluster density, or a combination thereof.

14. The method of claim 12, further comprising:
determining, by the one or more processors, centroids of multiple regions of interest, wherein the one or more regions of interest include the multiple regions of interest;
determining, by the one or more processors, an axis for each of the multiple regions of interest;
selecting, by the one or more processors, a vehicle geometry from a group of predefined vehicle geometries based on the centroids and the axis for each of the multiple regions of interest; and
estimating, by the one or more processors, the range based on selected vehicle geometry.

15. The method of claim 10, further comprising:
determining, by the one or more processors, a position of the second vehicle based on a position of the first vehicle, a field of view of a thermal imaging sensor of the first vehicle, a relative position of the thermal imaging sensor with respect to the first vehicle, or a combination thereof.

16. The method of claim 10, wherein the portion of the second vehicle includes one or more engines of the second vehicle, and wherein the one or more regions of interest correspond to the one or more engines or engine exhaust.

17. A non-transitory, computer readable medium storing instructions that, when executed by one or more processors, cause the one or more processors to perform operations comprising:
performing, at a first vehicle, thresholding on thermal image data to generate a thresholded thermal image including pixels having intensity values that satisfy a threshold, the thermal image data depicting at least a portion of a second vehicle;
identifying one or more regions of interest in the thresholded thermal image based on pixel characteristics associated with the one or more regions of interest; and
estimating a range between the first vehicle and the second vehicle based on the one or more regions of interest.

18. The non-transitory, computer readable medium of claim 17, wherein the operations further comprise:
grouping pixels in the thresholded thermal image into one or more clusters based on similarities between the pixel characteristics.

19. The non-transitory, computer readable medium of claim 18, wherein the pixel characteristics include pixel count, intensity value, cluster circularity, cluster size, cluster density, or a combination thereof.

20. The non-transitory, computer readable medium of claim 17, wherein the operations further comprise:
determining a position of the second vehicle based on a position of the first vehicle, a field of view of a thermal imaging sensor of the first vehicle, a relative position of the thermal imaging sensor with respect to the first vehicle, or a combination thereof.
